(19) United States
(12) Patent Application Publication
(10) Pub. No.: US 2015/0348132 A1
(43) Pub. Date: Dec. 3, 2015

(54) COMPETITIVE ADVERTISING TARGETING

(71) Applicant: MICROSOFT CORPORATION, REDMOND, WA (US)

(72) Inventors: VICTOR MAMICH, BELLEVUE, WA (US); HAIDAR YOUSIF, SNOQUALMIE, WA (US)

(73) Assignee: MICROSOFT CORPORATION, REDMOND, WA (US)

(21) Appl. No.: 14/287,855

(22) Filed: May 27, 2014

(51) Int. Cl. G06Q 30/02

(52) U.S. Cl. CPC G06Q 30/0275; G06Q 30/0259

(57) ABSTRACT

Methods, computer systems, and computer-storage media are provided for targeting advertising. Competitive advertising is an important aspect of advertising. To be effective, various influential factors of businesses may be evaluated to identify influence areas such that advertisers can easily identify areas that are susceptible to influence and those that may not be as susceptible. Once identified, bid adjustments may be made to each area such that advertisers are targeting areas with a higher return on investment.

### BACKGROUND

Radius targeting is commonly used by advertisers to target consumers. Radius targeting generally identifies a radius surrounding a particular location. The location may be a location associated with an advertiser (e.g., a storefront). A distance may be identified such that a radius of a predetermined distance surrounding the particular location is targeted. Thus, consumers within the radius may be targeted by an advertiser. This radius targeting does not take into account that consumers within the radius may not be near the particular location. For example, the consumer may not be near the advertiser's storefront location.

Travel time is a motivating factor for consumers when deciding on locations. Thus, a consumer may be within a given radius but a travel time to an advertiser's location may be twice the travel time for the same consumer to travel to a competitor location. Such considerations are not factors in radius targeting and, therefore, radius targeting may not be as effective as targeting based on consumer motivations such as, for example, travel time or other external influences.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Embodiments of the present invention relate to systems, methods, and computer-storage media for, among other things, targeting advertisements. As mentioned, the present invention seeks to target advertisements based on various factors. Consumer motivation may be influenced by factors more detailed than simply being within a proximity to a location, such as travel time.

A new type of advertising may be utilized based on competitive equations. An exemplary competitive equation is Competitive Lotka-Volterra equations. These equations may be models for predicting population dynamics of competitive businesses (e.g., advertisers, retailers, etc.) competing for common resources (e.g., consumers). The equations may model interactions and competitions for the consumers and the effect each competing business has on each other.

Accordingly, in one embodiment, the present invention is directed to one or more computer-storage media having computer-executable instruction embodied thereon that, when executed by one or more computing devices, perform a method of targeting advertisements. The method comprises, receiving an identification of a first advertiser; identifying a competitor advertiser; identifying an intersecting area based on a location of the first advertiser and a location of the competitor advertiser; and targeting the intersecting area for advertising by the first advertiser by increasing a bid associated with the intersecting area.

In another embodiment, the presented invention is directed to one or more computer-storage media having computer-executable instruction embodied thereon that, when executed by one or more computing devices, perform a method of targeting advertisements. The method comprises, receiving a location of a first advertiser; receiving a location of one or more competitor advertisers; identifying an intersecting area based on the location of the first advertiser and the location of the one or more competitor advertisers and an influence of each of the first advertiser and the one or more competitor advertisers, where the influence is an indication of a likelihood of a consumer to select a particular location over a different location; and targeting the intersecting area by increasing a bid associated advertisements to display to consumers within the intersecting area.

In yet another embodiment, the present invention is directed to one or more computer-storage media having computer-executable instruction embodied thereon that, when executed by one or more computing devices, perform a method of targeting advertisements. The method comprises, identifying a location associated with a first advertiser; identifying one or more locations associated with one or more competitor advertisers; identifying a difference area, wherein the difference area is an area within a predetermined distance from the location of the one or more competitor advertisers; identifying a local influence area, wherein the local influence area is an area within a predetermined distance from the location of the first advertiser; identifying an intersecting area, wherein the intersecting area is at least a portion of the difference area overlapping a portion of the local influence area; and associating a bid with each of the intersecting area, the difference area, and the local influence area.

### BRIEF DESCRIPTION OF THE DRAWINGS

The present invention is described in detail below with reference to the attached drawing figures, wherein:

FIG. 1 is a block diagram of an exemplary computing environment suitable for use in implementing embodiments of the present invention;

FIG. 2 is a block diagram of an exemplary system suitable for use in implementing embodiments of the present invention;

FIG. 3 depicts an illustrative screen display, in accordance with an embodiment of the present invention;

FIG. 4 depicts an illustrative screen display, in accordance with an embodiment of the present invention;

FIG. 5 is a flow diagram of an exemplary method of targeting advertisements in accordance with an embodiment of the present invention;

FIG. 6 is a flow diagram of an exemplary method of targeting advertisements in accordance with an embodiment of the present invention; and

FIG. 7 is a flow diagram of an exemplary method of targeting advertisements in accordance with an embodiment of the present invention.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Various aspects of the technology described herein are generally directed to systems, methods, and computer-storage media for, among other things, targeting advertisements. The present invention is directed to targeting advertisements to consumers based on various factors. Consumer motivation may be influenced by more factors than simply being within a proximity to a location, such as travel time.

While travel time is very important, other influences may exist as well such as, for example, which store is the closest, the size of each store within a predetermined radius, the neighborhood of each store, brands carried in each store, employees of each store, prices of products within the store, and the like. Consumers are more likely to choose a particular vendor based on these factors alone or in combination with travel time and not just based on a presence within a radius. Thus, advertisements may be more effective when presented to consumers that are more likely to be receptive to the advertisement. For instance, a consumer that is located five minutes from Store A and forty-five minutes from the next closest competitor is very unlikely to choose the competitor store. Thus, the advertiser associated with Store B is not likely to benefit from presenting advertisements, and thus, paying to present advertisements, to that consumer. Additionally, the advertiser associated with Store A may also not benefit from presenting an advertisement to that consumer since the consumer is most likely going to choose Store A anyway. The advertisement is most likely unnecessary in that situation.

Advertising targeting of the present invention may be performed by utilizing competitive equations. An exemplary competitive equation is Competitive Lotka-Volterra equations. These equations may be models for predicting population dynamics of competitive businesses (e.g., advertisers, retailers, etc.) competing for common resources (e.g., consumers). The equations may model interactions and competitions for the consumers and the effect each competing business has on each other to identify relevant consumers, as described above.

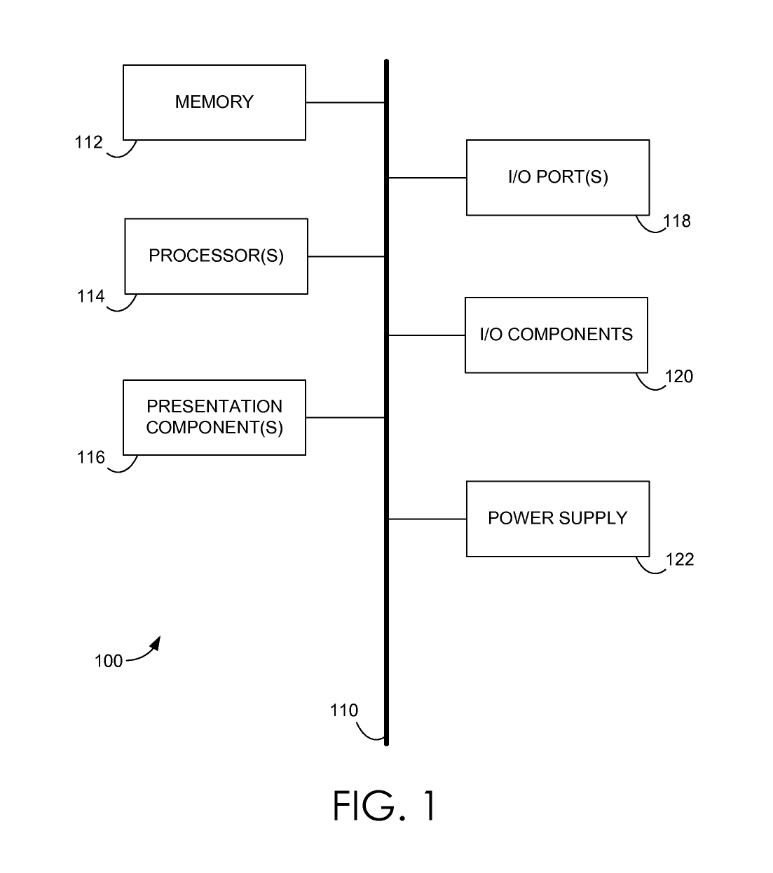

Having briefly described an overview of embodiments of the present invention, an exemplary operating environment in which embodiments of the present invention may be implemented is described below in order to provide a general context for various aspects of the present invention. Referring to the figures in general and initially to FIG. 1 in particular, an exemplary operating environment for implementing embodiments of the present invention is shown and designated generally as computing device 100. The computing device 100 is but one example of a suitable computing environment and is not intended to suggest any limitation as to the scope of use or functionality of embodiments of the invention. Neither should the computing device 100 be interpreted as having any dependency or requirement relating to any one or combination of components illustrated.

Embodiments of the invention may be described in the general context of computer code or machine-useable instructions, including computer-useable or computer-executable instructions such as program modules, being executed by a computer or other machine, such as a personal data assistant, a smart phone, a tablet PC, or other handheld device. Generally, program modules including routines, programs, objects, components, data structures, and the like, refer to code that performs particular tasks or implements particular abstract data types. Embodiments of the invention may be practiced in a variety of system configurations, including hand-held devices, consumer electronics, general-purpose computers, more specialty computing devices, etc. Embodiments of the invention may also be practiced in distributed computing environments where tasks are performed by remote-processing devices that are linked through a communications network. In a distributed computing environment, program modules may be located in both local and remote computer storage media including memory storage devices.

With continued reference to FIG. 1, the computing device 100 includes a bus 110 that directly or indirectly couples the following devices: a memory 112, one or more processors 114, one or more presentation components 116, one or more input/output (I/O) ports 118, one or more I/O components 120, and an illustrative power supply 122. The bus 110 represents what may be one or more busses (such as an address bus, data bus, or combination thereof). Although the various blocks of FIG. 1 are shown with lines for the sake of clarity, in reality, these blocks represent logical, not necessarily actual, components. For example, one may consider a presentation component such as a display device to be an I/O component. Also, processors have memory. The inventors hereof recognize that such is the nature of the art, and reiterate that the diagram of FIG. 1 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 1 and reference to “computing device.”

The computing device 100 typically includes a variety of computer-readable media. Computer-readable media may be any available media that is accessible by the computing device 100 and includes both volatile and nonvolatile media, removable and non-removable media. Computer-readable media comprises computer storage media and communication media; computer storage media excludes signals per se. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 100. Computer storage media does not comprise signals per se. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

The memory 112 includes computer-storage media in the form of volatile and/or nonvolatile memory. The memory may be removable, non-removable, or a combination thereof. Exemplary hardware devices include solid-state memory, hard drives, optical-disc drives, and the like. The computing device 100 includes one or more processors that read data from various entities such as the memory 112 or the I/O components 120. The presentation component(s) 116 present data indications to a user or other device. Exemplary presentation components include a display device, speaker, printing component, vibrating component, and the like.

The I/O ports 118 allow the computing device 100 to be logically coupled to other devices including the I/O components 120, some of which may be built in. Illustrative I/O components include a microphone, joystick, game pad, satellite dish, scanner, printer, wireless device, a controller, such as a stylus, a keyboard and a mouse, a natural user interface (NUI), and the like. An NUI processes air gestures, voice, or other physiological inputs generated by a user. These inputs may be interpreted as search prefixes, search requests, requests for interacting with intent suggestions, requests for interacting with entities or subentities, or requests for interacting with advertisements, entity or disambiguation tiles, actions, search histories, and the like presented by the computing device 100. These requests may be transmitted to the appropriate network element for further processing. A NUI implements any combination of speech recognition, touch and stylus recognition, facial recognition, biometric recognition, gesture recognition both on screen and adjacent to the screen, air gestures, head and eye tracking, and touch recognition associated with displays on the computing device 100. The computing device 100 may be equipped with depth cameras, such as, stereoscopic camera systems, infrared camera systems, RGB camera systems, and combinations of these for gesture detection and recognition. Additionally, the computing device 100 may be equipped with accelerometers or gyroscopes that enable detection of motion. The output of the accelerometers or gyroscopes is provided to the display of the computing device 100 to render immersive augmented reality or virtual reality.

Aspects of the subject matter described herein may be described in the general context of computer-executable instructions, such as program modules, being executed by a computing device. Generally, program modules include routines, programs, objects, components, data structures, and so forth, which perform particular tasks or implement particular abstract data types. Aspects of the subject matter described herein may also be practiced in distributed computing environments where tasks are performed by remote processing devices that are linked through a communications network. In a distributed computing environment, program modules may be located in both local and remote computer storage media including memory storage devices.

Furthermore, although the term “server” is often used herein, it will be recognized that this term may also encompass a search engine, a Web browser, a cloud server, a set of one or more processes distributed on one or more computers, one or more stand-alone storage devices, a set of one or more other computing or storage devices, a combination of one or more of the above, and the like.

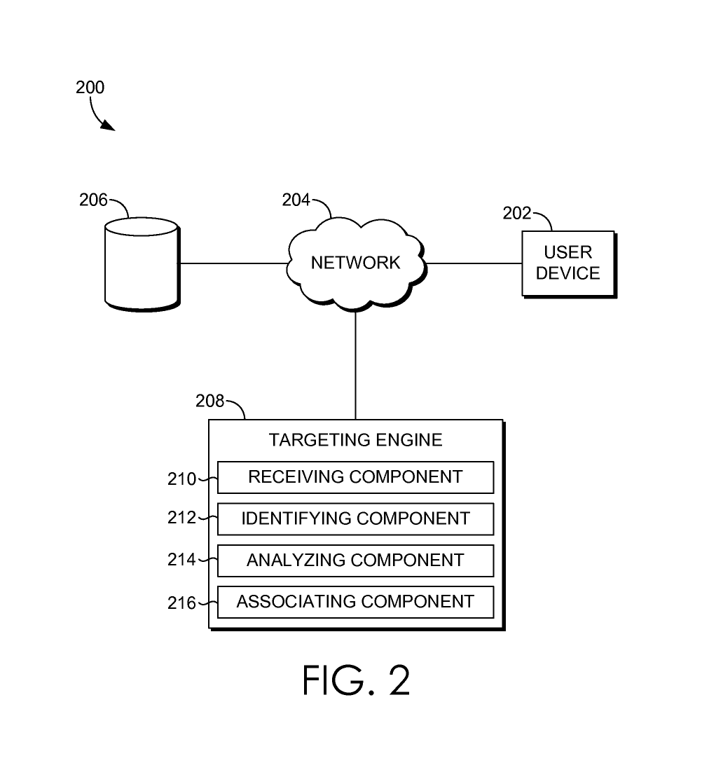

Referring now to FIG. 2, a block diagram is provided illustrating an exemplary computing system 200 in which embodiments of the present invention may be employed. Generally, the computing system 200 illustrates an environment where consumers may be targeted based on competitive influences. The system may include a user device 202. The user device 202 may be any device configured to perform targeting using embodiments of the present invention. The user device 202 may be, for example, a device comparable to that described in FIG. 1.

Among other components not shown, the computing system 200 generally includes a network 204, a database 206, and a targeting engine 208. The targeting engine 208 may include a receiving component 210, an identifying component 212, an analyzing component 214, and an associating component 216.

The network 204 may include, without limitation, one or more local area networks (LANs) and/or wide area networks (WANs). Such networking environments are commonplace in offices, enterprise-wide computer networks, intranets and the Internet. Accordingly, the network 204 is not further described herein.

The targeting engine 208 may be configured for, among other things, targeting advertisements to specific consumers, locations, etc. The targeting engine 208 may include, among other components, a receiving component 210, an identifying component 212, an analyzing component 214, and an associating component 216.

The receiving component 210 may be configured for, among other things, receiving advertising input(s). Advertising input, as used herein, refers generally to any information related to an advertising campaign. In particular, advertising input may include but is not limited to one or more locations associated with an advertiser, one or more competitors, one or more locations associated with one or more competitors, a radius relative to a location, one or more bids, one or more bid adjustments, and the like.

Advertising input may be input manually or may be automatically generated. With respect to locations, in particular, an advertiser creating an advertising platform may manually input one or more competitors, competitor locations, or the like. For instance, an advertiser may manually input known competitors. Advertisers may create and maintain lists of known competitors for future use

Alternatively, an automatically generated list of nearby competitors may be identified (by, for example, the identifying component 212) based on competitor information stored in, for example, database 206. All business locations may be stored as well as all keywords competing in a local area. By cross-referencing the keywords, the system may automatically determine businesses that are in direct competition with one another. For instance, if an advertiser is a shoe retailer, the system may search database 206 for other competitors in the area that are associated with shoe retail to identify potential competitors. Once identified, an advertiser may edit the automatically generated list. For instance, an advertiser may want to include addition competitors or, perhaps, may not want to include a competitor included in the automatically generated list. The advertiser has the ability to add or remove competitors as desired even when the competitors are automatically identified.

The analyzing component 214 is configured for, among other things, identifying business area influence. The analyzing component 214 may utilize competitive equations to identify business influence. For example, the analyzing component 214 may utilize Lotka-Volterra equations to calculate business influence. Various factors may be evaluated by the analyzing component 214 as weighing into the business influence. In an embodiment, all businesses are assumed to have an equal influence. Advertisers, again, have the ability to edit the results of the analyzing component 214. For instance, should an advertiser feel that an influence of a competitor is not as large as determined by the analyzing component 214, the advertiser may edit the influence of the competitor.

When not assumed equal, the analyzing component 214 may identify business influence based on various factors. Factors include travel time, type of business, advertising budget, and the like. In embodiments, travel time is the default calculation (i.e., travel time from a hypothetical consumer to location of the competitor location, the advertiser location, or the like).

Influence may be manually input either initially or as edits to an automatically generated influence calculation. Advertisers may possess knowledge of many intangibles or inexact data that is not known to the system 200 or cannot be known to the system 200. For instance, convenience of a location, hours, product selection, friendliness of the staff, surrounding neighborhoods (e.g., a local customer would know that a competitor resides in a high crime area and would be less likely to travel to that area), relative prices (e.g., few customers would travel twice as far to buy half as much product), recent changes in management or procedures, return policies, traffic at a particular time of day, relative status of a competitor (e.g., if the competitor's store front owner is also a famous athlete more business is likely to be derived from that status), or the like. Even though an advertiser's judgment dictates influence in this example, a default influence radius may still be relied on as to type of business. The system 200 may develop statistical models and use regression analysis to find a standard influence of each type of business (e.g., restaurant, convenience store, etc.) to use as a default. An exemplary regression analysis may include identifying businesses with similar budgets and keywords and identifying which advertisement is clicked on from existing advertisements. If the system identifies a point where users click on advertisements even though the advertisement ranking should say their behavior should be different, it may be inferred that the system is outside of standard influence radius boundary. It is important to note that this would be performed with large amounts of data to recognize a pattern. The next regression analysis may be to vary the budget to identify how that influences behavior. In embodiments utilizing advertising budget, confidentiality must be maintained and as such, information derived from the advertising budget may not be presented to a user in certain forms. For instance, when the advertising budget is utilized to calculate influence, graphical depictions of the influence may not be presented to a user.

The analyzing component 214 may also be configured to identify targeting areas and recommend suggested strategies. For instance, the analyzing component 214 may identify that a particular area is of interest to an advertiser and, in turn, recommend increasing a bid associated with that area. This analysis may be based on, among other things, a return on investment. For instance, if there is a very slim chance that a consumer will select the advertiser, it is not a wise business investment to spend money targeting the consumer. Additionally, if there is a very high likelihood that a consumer is going to choose the advertiser, it may not make sense to advertise to that consumer since you likely already have their business. Thus, the advertiser would be saving money that does not need to be spent.

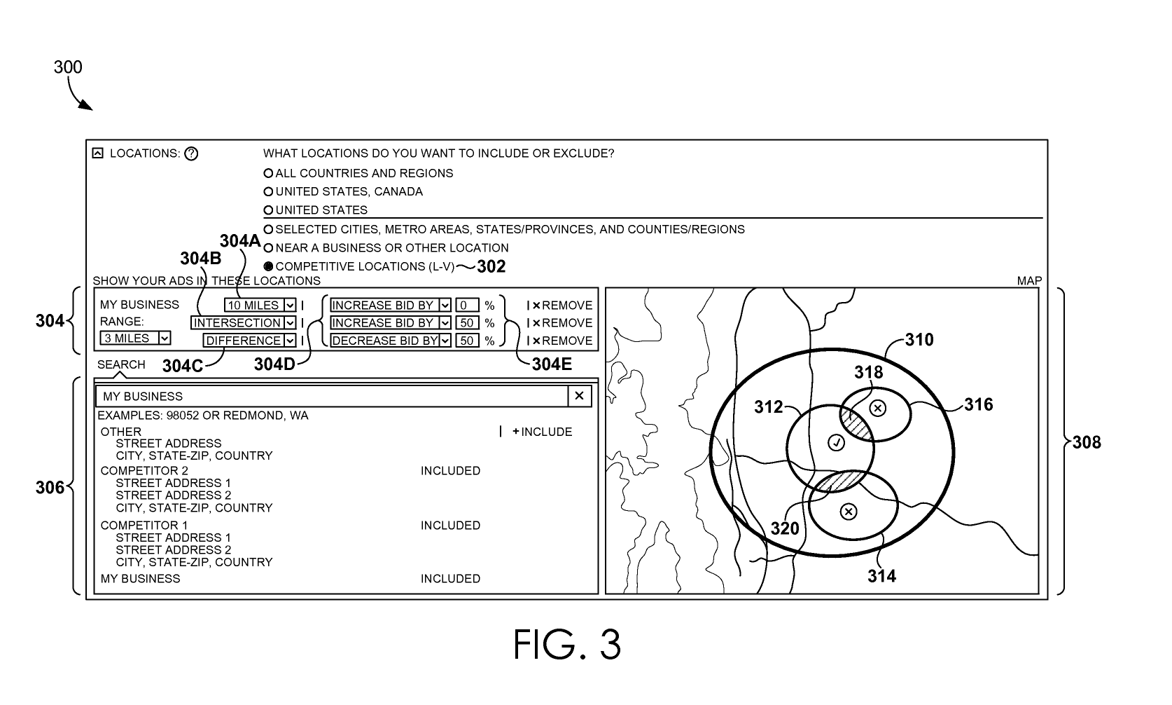

Once the influences are calculated, the system 200 may chart the influences. An exemplary chart is displayed in FIG. 3. As will be discussed in detail below, charts may include a radius, an intersecting area, a local influence area, and a difference area. The charts may be Venn diagrams. The radius may indicate a total radius given by, for example, an advertiser to limit an area evaluated. The radius may be relative to any given location. For example, the radius may be a 50 mile radius from a location associated with the advertiser.

A local influence area may be an area within a predetermined distance from the location associated with the advertiser. The local influence area may represent an area in proximity to the advertiser that is heavily influenced by the advertiser. For instance, the area immediately surrounding the location associated with the advertiser may be assumed to be dominated by the advertiser.

A difference area may be an area within a predetermined distance from a location associated with a competitor advertiser. Additionally, the difference area may be a predetermined distance from the location associated with the advertiser and the distance from the advertiser is greater than the distance from the competitor advertiser. The difference area may represent the inverse of the local influence area. That is, the difference area may represent the area in proximity to a location of a competitor advertiser such that the influence of the competitor advertiser is assumed to be very strong.

An intersecting area may represent an area of overlap between the difference area and the local influence area. The intersecting area may be an area of opportunity for advertisers as the consumers in this area may be easier to influence than those in the difference area. The intersecting area may represent an area of high competition.

FIG. 3 provides an exemplary user interface 300 for embodiments of the present invention. The interface 300 includes a competitive selection area 302 for a user to select the competitor mode and an advertiser selection area 304 that includes a radius input area 304A, an intersecting input area 304B, a difference input area 304C, a bid adjustment area 304D, and a bid indication area 304E. The radius input area 304A allows an advertiser to indicate a desired radius. As illustrated in user interface 300, an advertiser has selected 10 miles for a radius. The radius is depicted in a map area 308 by radius indicator 310. An advertiser then selects an intersecting input in intersecting input area 304B. The advertiser may then select a difference area input in difference input area 304C. In this example, the advertiser has selected 3 miles as the difference. Once the values are entered, the map area 308 displays the different areas. As previously described, the radius is depicted by radius indicator 310. The local influence area is indicator 312.

Difference areas may be provided for each competitor listed in a competitor list area 306. The competitors may be provided in various ways as described above. In the present example, two competitors are selected. A difference area indicator is provided for each and depicted as indicator 314 and indicator 316. Similarly, an intersecting area will be provided for each as each difference area overlaps with the local influence area. The intersecting areas are depicted as indicators 318 and 320.

A user may adjust bids in the bid adjustment area 304D. Each bid may be increased, decreased, or not adjusted. The increase or decrease will be to a standard bid already provided by the user. The adjustments may be reflected in the bid indication area 304E. Percentages have been provided in the present example but any form of an increase or decrease may be utilized such as, for example, monetary amounts.

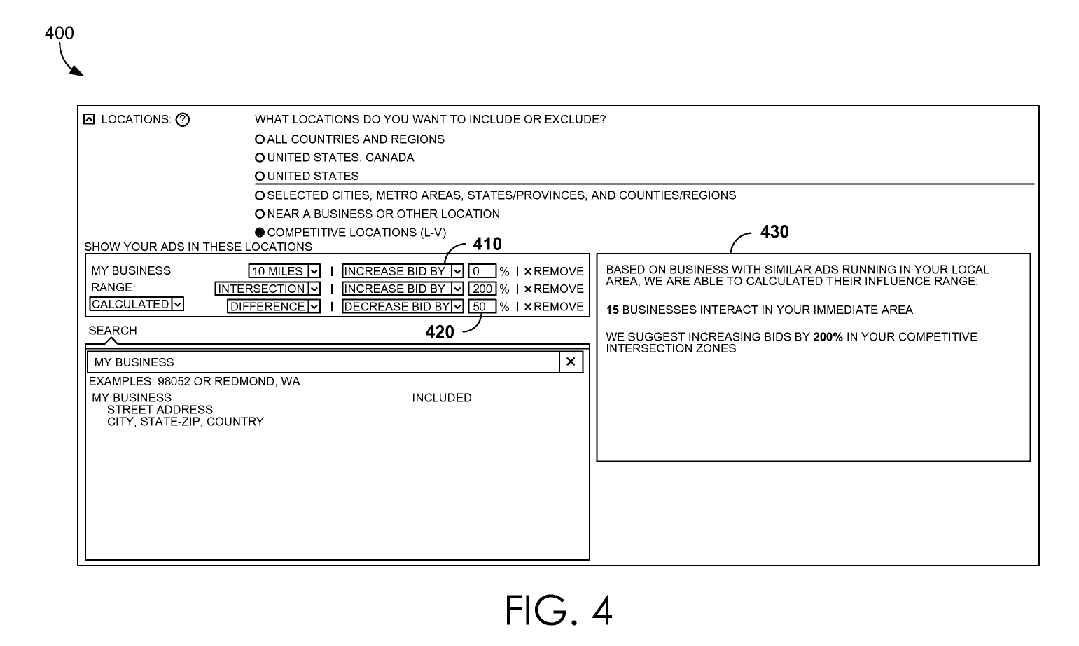

In embodiments, bid adjustments are suggested to a user. FIG. 4 provides an exemplary user interface 400 to provide information to a user. Bid adjustment suggestions may be provided to a user upon selection of a bid adjustment indicator 410 or a bid indication indicator 420. The bid suggestions may be presented in a suggestion area 430. The suggestion area may also include suggested competitors identified by the system 200. The user may select the suggested businesses or may choose to discard the businesses. Additionally, the suggested bid may be edited by the user. In an embodiment, the suggested is automatically included in the bid indication area and may be edited or removed by a user.

Returning to FIG. 2, once boundaries have been identified, the associating component 216 may be configured to, among other things, associate a bid with different areas. Advertisers may increase or decrease their bids based on locations. For instance, an advertiser may choose to increase a bid associated with the intersecting area since that may be assumed to have a high return on investment as the consumers in that area may be susceptible to influence. Alternatively, an advertiser may lower bids associated with other areas identified as having a low return on investment such as, for example, the difference area. Once the bids are input by the advertiser, the associating component 216 may associate the bid with the corresponding area.

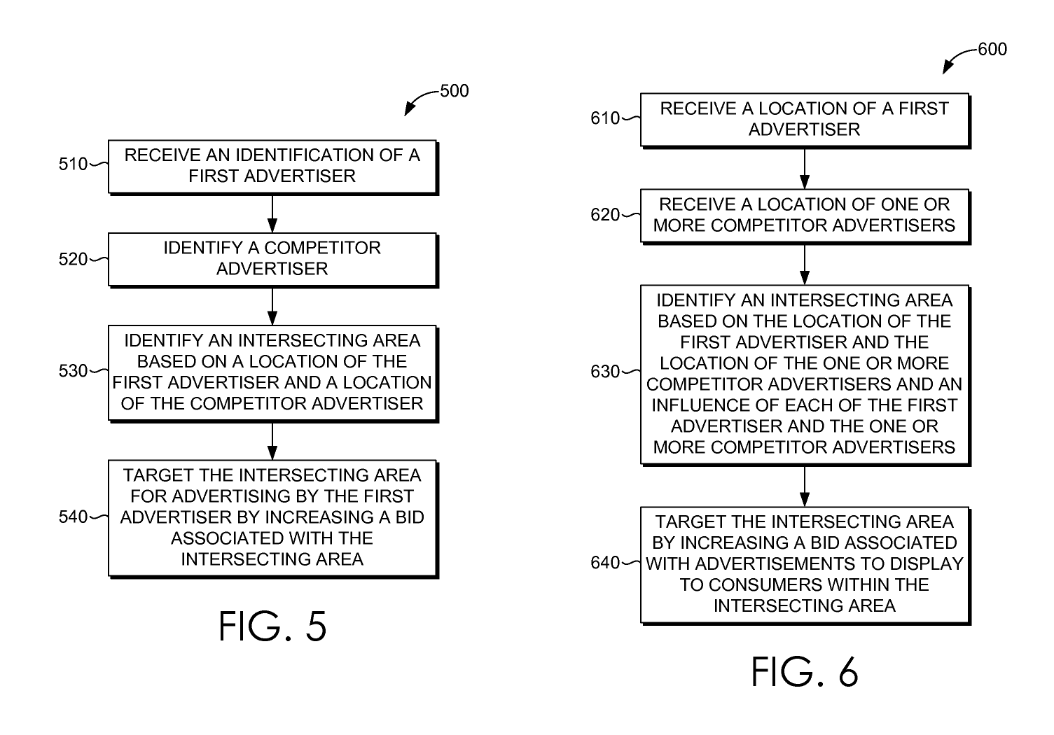

Turning now to FIG. 5, a flow diagram is depicted of an exemplary method 500 of the present invention. At block 510, an identification of a first advertiser is received. A competitor advertiser is identified at block 520. An intersecting area is identified at block 530 based on a location of a first advertiser and a location of the competitor advertiser. At block 540 the intersecting area is targeted for advertising by the first advertiser by increasing a bid associated with the intersecting area.

FIG. 6 is a flow diagram of an exemplary method 600 of the present invention. At block 610 a location of a first advertiser is received. At block 620 a location of one or more competitor advertisers is received. An intersecting area is identified at block 630 based on the location of the first advertiser and the location of the one or more competitor advertisers and an influence of each of the first advertiser and the one or more competitor advertisers. An influence is an indication of a likelihood of a consumer to select a particular location associated with an advertiser over a different location(s) associated with one or more competitors. At block 640 the intersecting area is targeted by increasing a bid associated with advertisements to display to consumers within the intersecting area.

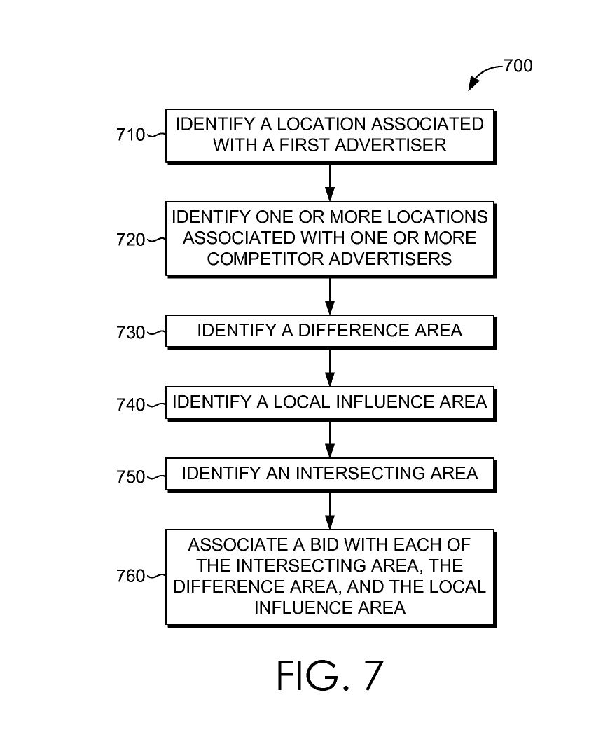

FIG. 7 is a flow diagram of an exemplary method 700 of the present invention. At block 710 a location associated with a first advertiser is identified and at block 720 one or more locations associated with one or more competitor advertisers is identified. At block 730 a difference area is identified. At block 740 a local influence area is identified. At block 750 an intersecting area is identified. At block 750 a big is associated with each of the intersecting area, the difference area, and the local influence area. The bids may be different.

The present invention has been described in relation to particular embodiments, which are intended in all respects to be illustrative rather than restrictive. Alternative embodiments will become apparent to those of ordinary skill in the art to which the present invention pertains without departing from its scope.

What is claimed is:

1. One or more computer-storage media having computer-executable instructions embodied thereon that, when executed by one or more computing devices, perform a method, the method comprising:
receiving an identification of a first advertiser;
identifying a competitor advertiser;
identifying an intersecting area based on a location of the first advertiser and a location of the competitor advertiser, wherein a location is a physical real-world location associated with advertisers; and
targeting the intersecting area for advertising by the first advertiser by increasing a bid associated with the intersecting area.

2. The media of claim 1, wherein the competitor advertiser is identified via manual input by the first advertiser.

3. The media of claim 1, wherein the competitor advertiser is identified via a search of a competitor advertiser database.

4. The media of claim 1, wherein the intersecting area is adjustable.

5. The media of claim 1, further comprising decreasing a bid associated with a difference area.

6. The media of claim 5, wherein the difference area is an area within a predetermined distance from the location of the competitor advertiser.

7. The media of claim 1, wherein the intersecting area is further identified based on an influence of the competitor advertiser and the first advertiser.

8. The media of claim 1, further comprising decreasing a bid associated with a local influence area.

9. The media of claim 8, wherein the local influence area is an area within a predetermined distance from the location of the first advertiser.

10. One or more computer-storage media having computer-executable instructions embodied thereon that, when executed by one or more computing devices, perform a method, the method comprising:
receiving a location of a first advertiser;
receiving a location of one or more competitor advertisers;
identifying an intersecting area based on the location of the first advertiser and the location of the one or more competitor advertisers and an influence of each of the first advertiser and the one or more competitor advertisers, wherein the influence is an indication of a likelihood of a consumer to select a particular location over a different location; and
targeting the intersecting area by increasing a bid associated with advertisements to display to consumers within the intersecting area.

11. The media of claim 10, further comprising identifying a difference area, wherein the difference area is an area within a predetermined distance from the location of the one or more competitor advertisers.

12. The media of claim 11, further comprising identifying a local influence area, wherein the local influence area is an area within a predetermined distance from the location of the first advertiser.

13. The media of claim 12, further comprising receiving a bid associated with the local influence area and a bid associated with the difference area.

14. The media of claim 13, wherein each of the bid associated with the difference area and the bid associated with the local influence area is different from the bid associated with advertisements to display to consumers within the intersecting area.

15. The media of claim 14, wherein the bid associated with advertisements to display to consumers within the intersecting area is higher than each of the bid associated with the difference area and the bid associated with the local influence area.

16. One or more computer-storage media having computer-executable instructions embodied thereon that, when executed by one or more computing devices, perform a method, the method comprising:
identifying a location associated with a first advertiser;
identifying one or more locations associated with one or more competitor advertisers;
identifying a difference area, wherein the difference area is an area within a predetermined distance from the location of the one or more competitor advertisers;
identifying a local influence area, wherein the local influence area is an area within a predetermined distance from the location of the first advertiser;
identifying an intersecting area, wherein the intersecting area is at least a portion of the difference area overlapping at least a portion of the local influence area; and
associating a bid with each of the intersecting area, the difference area, and the local influence area.

17. The media of claim 16, wherein a bid is a monetary amount the first advertiser is associating with an advertisement.

18. The media of claim 16, wherein the one or more competitor advertisers is identified via manual input by the first advertiser.

19. The media of claim 16, wherein the competitor advertiser is identified via a search of a competitor advertiser database.

20. The media of claim 16, wherein the bid associated with the intersecting area is higher than the bid associated with the local influence area and higher than the bid associated with the difference area.
